(19) United States
(12) Patent Application Publication
(10) Pub. No.: US 2026/0336561 A1
(43) Pub. Date: Oct. 29, 2026

(54) DIGITAL VEHICLE KEY PROVIDING FOR LIMITED USE OF A VEHICLE

(71) Applicant: Google LLC, Mountain View, CA (US)

(72) Inventors: Emelie Jess Ashdown, San Diego, CA (US); Nicholas Ryan Miller, Brooklyn, NY (US)

(21) Appl. No.: 19/491,191

(22) PCT Filed: Jul. 21, 2023
(86) PCT No.: PCT/US2023/028406

§ 371 Date: Dec. 8, 2025

(51) Int. Cl. B60R 25/24; B60R 25/01; G07C 9/00

(52) U.S. Cl. CPC B60R 25/24; B60R 25/01; G07C 9/00309; G07C 2009/00793; G07C 2209/08

(57) ABSTRACT

Providing limited access and/or use of a vehicle includes receiving, by a vehicle, a limited use digital vehicle key, the limited, use digital vehicle key indicating one or more conditions for one or more of access to and use of the vehicle; verifying, by the vehicle, the limited use digital vehicle key based at least in part on a vehicle state of die vehicle; and in response to verifying the limited use digital vehicle, allowing, by the vehicle, at least one of access to and use of the vehicle in response to one or more conditions of the limited use digital vehicle key matching the vehicle state.

### BACKGROUND

Some vehicles provide the capability to receive a digital vehicle key (DVK) from a portable computing device to, when authenticated, unlock a door of the vehicle, start the engine of the vehicle, or perform another function. Some problems may occur when attempting to use a DVK. For example, the portable computing device (such as a smart phone or smart watch) providing the DVK may be locked, and the vehicle owner (or other person responsible for the vehicle) may be unable to unlock the portable computing device; the portable computing device may have run out of battery life and be inoperable; or the portable computing device may be lost, stolen, or broken. When the portable computing device cannot provide the DVK to the vehicle and the owner does not currently possess a physical vehicle key, the owner may be unable to access the vehicle.

### SUMMARY

In general, the techniques of this disclosure are directed to a portable computing device that may allow an owner (or other responsible person) of a vehicle to create a limited use digital vehicle key (DVK) and provide the limited use DVK to another party's (e.g., a user)'s computing device. The limited use DVK may include conditions on the access and/or use of the vehicle, which may be restricted, for example, by time, location, speed limit, acceleration limit, application of braking, function, or other limitation. The user may then cause the user's computing device to provide the limited use DVK to the vehicle. In response to receiving the limited use DVK, the vehicle may verify the limited use DVK and, when verified, provide access by the user to the vehicle only as provided for by the conditions specified by or indicated by the limited use DVK.

In some aspects, the techniques described herein relate to a method including receiving, by a vehicle, a limited use digital vehicle key, the limited use digital vehicle key indicating one or more conditions for one or more of access to and use of the vehicle; verifying, by the vehicle, the limited use digital vehicle key based at least in part on a vehicle state of the vehicle; and in response to verifying the limited use digital vehicle, allowing, by the vehicle, at least one of access to and use of the vehicle in response to the one or more conditions of the limited use digital vehicle key matching the vehicle state.

In some aspects, the techniques described herein relate to a vehicle including a vehicle state; and digital vehicle key circuitry to receive a limited use digital vehicle key, the limited use digital vehicle key indicating one or more conditions for one or more of access to and use of the vehicle; verify the limited use digital vehicle key based at least in part on the vehicle state; and in response to verifying the limited use digital vehicle, allow at least one of access to and use of the vehicle in response to the one or more conditions of the limited use digital vehicle key matching the vehicle state.

In some aspects, the techniques described herein relate to an apparatus including: means for receiving, by a vehicle, a limited use digital vehicle key, the limited use digital vehicle key indicating one or more conditions for one or more of access to and use of the vehicle; means for verifying, by the vehicle, the limited use digital vehicle key based at least in part on a vehicle state of the vehicle; and in response to verifying the limited use digital vehicle, means for allowing, by the vehicle, at least one of access to and use of the vehicle in response to the one or more conditions of the limited use digital vehicle key matching the vehicle state.

In some aspects, the techniques described herein relate to a non-transitory computer-readable storage medium including instructions, that when executed by one or more processors of a computing system, cause the one or more processors to receive, by a vehicle, a limited use digital vehicle key, the limited use digital vehicle key indicating one or more conditions for one or more of access to and use of the vehicle; verify, by the vehicle, the limited use digital vehicle key based at least in part on a vehicle state of the vehicle; and in response to verifying the limited use digital vehicle, allow, by the vehicle, at least one of access to and use of the vehicle in response to the one or more conditions matching the vehicle state.

The details of one or more examples are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a conceptual diagram illustrating an example computing environment for creating and using a limited use digital vehicle key, in accordance with one or more aspects of the present disclosure.

FIG. 2 is a block diagram illustrating further details of an example computing system, in accordance with one or more aspects of the present disclosure.

FIG. 3 is a flow chart of an example process for example computing systems to create and use a limited use digital vehicle key, in accordance with aspects of this disclosure.

FIG. 4 is a flow chart of an example process for example computing systems to receive and verify a limited use digital vehicle key, in accordance with aspects of this disclosure.

### DETAILED DESCRIPTION

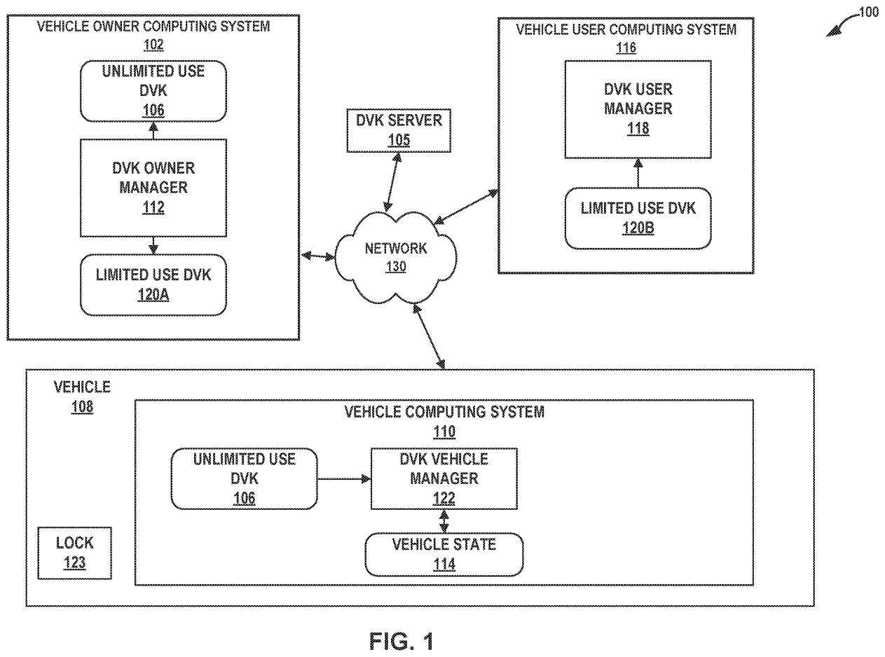

FIG. 1 is a conceptual diagram illustrating an example computing environment for creating and using a limited use digital vehicle key, in accordance with one or more aspects of the present disclosure. In some scenarios, an owner may desire to provide a digital vehicle key (DVK) for a vehicle 108 to another party (e.g., a family member, friend, co-worker, etc.). The other party may store the DVK in their computing device (which may or may not be portable). Then, if the owner has a problem with his or her portable computing device when attempting to access the vehicle, the owner may have the other party use the DVK from their computing device to allow the user to access the vehicle. In another scenario, the owner may want the other party to access the vehicle even when the owner cannot do so (e.g., the owner is not in the same location as the vehicle). For example, the other party may be a family member, a friend, a renter of the vehicle, a mechanic, a car dealer, a parking lot attendant, an insurance company representative, etc., who needs temporary access to and/or use of the vehicle. In some cases, the other party's computing device may be a computing system accessing the vehicle over a network from a location different than the vehicle's location. However, in these scenarios the owner may not want to give the other party complete and unlimited access to and/or use of the vehicle.

Various scenarios for the use of digital vehicle keys in this context are contemplated. For example, the owner may want to rent the vehicle using a third-party rental service. After notifying the third-party rental service and creating an agreement with the rental service, the owner may then create a limited license digital vehicle key and assign that new limited license digital vehicle key to the third-party rental service. The third-party rental service then finds a renter of the vehicle and creates a limited use digital vehicle key for the renter that is limited according to the limited license agreed to by the owner. When the time for the rental arrives, the owner puts the vehicle into the “Rental” vehicle state, thereby allowing the limited use digital vehicle key that was extended from the third party's limited license key to be successfully verified by the vehicle. That renter may then use the vehicle within the one or more conditions of the limited use digital vehicle key received from the third-party rental service. When the time for the rental is over, the owner may then change the state of the vehicle out of “Rental” vehicle state and back to a normal vehicle state, and the limited license digital vehicle key belonging to the third party may be deactivated, and the limited use digital vehicle key associated with that third party's limited license digital vehicle key would be terminated as well.

In another example, assume an owner's computing system used to control the vehicle (such as smart phone) is inoperable (e.g., battery dead, broken, no network connectivity, etc.) and incapable of communicating with the vehicle in any capacity. Assume also that the owner has extended a limited license digital vehicle key to the owner's insurance company or third-party roadside assistance company. The owner may be able to call the roadside assistance company (perhaps using another phone), and after authentication of the owner, the owner may ask the roadside assistance company to allow the owner to enter the vehicle and start the vehicle. The roadside assistance company may then utilize the permissions of the limited license digital vehicle key received from the owner to put the vehicle into a “Roadside Assistance” vehicle state. This authorizes their limited license digital vehicle key to complete remote key exchange (RKE) actions over a network (“over the air”). The roadside assistance company may then unlock the vehicle and start the vehicle for the owner using this “over the air” digital vehicle key. The owner may then drive to a safe location (e.g., the owner's home). Once the owner has gained access again to the owner's computing system (e.g., recharged phone battery, purchased a new phone or new computer, etc.), the owner may reset the vehicle state to a normal vehicle state. This would prevent the roadside assistance company from further over the air RKE actions until a subsequent authorization by the owner.

At times the owner may need to take the vehicle to a mechanic for service. The owner may set the vehicle state to a “Repair” status and give the mechanic a limited use digital vehicle key to allow the mechanic to access and/or use the vehicle as needed to be able to perform maintenance and/or repair services on the vehicle. Once the services are completed and the owner retrieves the vehicle from the mechanic, the owner removes the “Repair” status in the vehicle state of the vehicle (and sets the vehicle state back to normal), thus deactivating the mechanic's limited use digital vehicle key.

After an accident, the owner's insurance company determines that vehicle is a total loss. While the owner is away from the vehicle, with the owner's computing system (e.g., smart phone) away from the vehicle, the insurance company is to take ownership of the vehicle so that the owner can receive the insurance benefits. The vehicle may use one or more sensors (e.g., a crash sensor) to determine that there has been serious damage to the vehicle and the vehicle sets the vehicle state to an “Insurance” mode. This action may activate a limited use digital vehicle key for the insurance company and allows the insurance company to send an agent to utilize RKE actions over the air and move the vehicle as needed.

Accordingly, an owner (or other responsible party) of a vehicle 108 may want to allow another party (a user) to access and/or use the owner's vehicle using a DVK. For example, the owner may want to lend the vehicle to a friend for only a certain time. The owner may allow a family member (e.g., a son or daughter) to use the vehicle but only under certain operating conditions (e.g., with a specified maximum speed, maximum acceleration, maximum braking conditions, location, time periods during a day, etc.). The owner may rent the vehicle to a renter for a specified time under certain conditions. The owner may want a mechanic or a car dealer to be able to access and/or use the vehicle for maintenance or inspection purposes. The owner may want an insurance company to inspect the vehicle at a location apart from the owner's location. The owner may want a roadside assistance company to access the vehicle for purposes of repair or towing. Other use cases are possible.

Thus, the owner may want to restrict the access to and/or use of the owner's vehicle by the other party. Currently, an owner can transfer a DVK for the vehicle 108 to the other party, but in some cases the DVK may not have restrictions on use. This may be undesirable.

The technology described in the present disclosure provides a mechanism for an owner (or other responsible party) to create a limited use DVK 120A specifying or indicating one or more conditions of use of the vehicle 108. The owner sends the limited use DVK 120A to the user allowed by the owner to access or use the owner's vehicle via any communications mechanism (resulting in a copy denoted limited use DVK 120B in FIG. 1). The user may store the received limited use DVK 120B (e.g., in the vehicle user's computing system 116 (which may be a smart phone, smart watch, personal computer, tablet computer, server, or other computing device) and subsequently provide the limited use DVK 120B to the vehicle's computing system 110. The vehicle's computing system 110 verifies the limited use DVK 120B and provides access to and/or use of the vehicle 108 only in response to one or more the conditions specified by the limited use DVK matching a current state of the vehicle.

A technical effect of this technology is that an owner may use his or her computing system to provide limited use access capability to the owner's vehicle remotely to another user via the user's computing system and a network. The vehicle prevents a user from accessing the vehicle if the digital vehicle key provided to the vehicle is not authorized and only within the one or more conditions set by the digital vehicle key.

DVK computing environment 100 includes vehicle owner computing system 102 operated by an owner of vehicle 108. As used herein, an owner may be a person holding legal title to vehicle 108 or anyone authorized by the owner to be primarily responsible for the vehicle (e.g., a lessee, a family member, an employee, etc.). Vehicle owner computing system 102 may be configured with digital key technology to facilitate accessing and/or using vehicle 108.

DVK computing environment 100 includes DVK server 105, which communicates with vehicle computing system 110 in vehicle 108, to update one or more lists of one or more authorized DVKs for the vehicle, permissions, and conditions of use. DVK server 105 may also communicate with vehicle owner computing system 102 for creation and/or distribution of DVKs for vehicle 108 to vehicle user computing system 116. DVK server 105 may also communicate with vehicle user computing system 116 to provision a limited use DVK. In an example, DVK server 105 may be operated by a manufacturer of the vehicle or by a third-party provider.

Vehicle 108 may be a car, truck, van, boat, plane, motorcycle, all-terrain vehicle (ATV), etc. Although only one vehicle is shown in FIG. 1, the processing detailed herein for vehicle owner computing system 102 may be used for a plurality of vehicles of various kinds. The act of accessing the vehicle may, for example, involve gaining entry to the vehicle, such as unlocking a door via lock 123 or trunk/frunk of the vehicle, etc. Alternatively, or additionally, the act of accessing and/or using the vehicle may involve changing an operating state of the vehicle, such as turning on an engine of the vehicle, turning off the engine of the vehicle, disarming a security system, turning on the stereo, moving a power seat, changing control settings (e.g., heat, air conditioning), disabling a battery, enabling a battery, etc. In an implementation, vehicle 108 includes at least lock 123, vehicle computing system 110 and vehicle state 114. Vehicle computing system 110 may include any computing device associated with or embedded in the vehicle for performing processing for the vehicle.

Vehicle state 114 may describe a current desired system state of the vehicle. In an implementation, vehicle state 114 may include unlimited use or a restriction of temporary limited use (e.g., by a temporary user) such as a restriction of limited use for a family member, limited use for a friend, limited use for a renter, limited use for a mechanic, limited use for a car dealer, limited use for an insurance adjuster, limited use for a roadside assistance company, or any other state defined by the owner of the vehicle. In an implementation, owner, via vehicle owner computing system 102, may set the current value of the vehicle state 114. Vehicle state 114 may be stored in a storage device in or accessible by vehicle computing system 110. In an implementation, vehicle state 114 may be set by the owner to a rental operating status for use by a temporary renter of the vehicle and one of the conditions of the limited use DVK may be a rental operating status. Vehicle state 114 may be set by the owner to a repair operating status for use by a mechanic or other service professional of the vehicle and one of the conditions of the limited use DVK may be a repair operating status. Vehicle state 114 may be set by the owner to a roadside assistance operating status for use by a roadside assistance service of the vehicle and one of the conditions of the limited use DVK may be a roadside assistance operating status. Vehicle state 114 may be set by the owner to an insurance status for use by a vehicle insurance company of the vehicle and one of the conditions of the limited use DVK may be an insurance operating status. Vehicle state 114 may be set by vehicle 108 based at least in part on one or more operating statuses of the vehicle indicating the vehicle is inoperable, to at least one of a repair state, a roadside assistance state and an insurance state, prior to verifying the limited use DVK 120B.

Vehicle owner computing system 102 may include DVK owner manager 112 to create DVKs, send DVKs to vehicle 108 (optionally, via DVK server 105), send DVKs to one or more users (optionally, via DVK server 105), and send an updated vehicle state 114 to vehicle 110 (optionally, via DVK server 105). In one scenario, vehicle state 114 may be set by the vehicle itself (instead of being set by the vehicle owner) based on one or more operating statuses of the vehicle (e.g., a crash of the vehicle has been detected, the vehicle has broken down, one or more components of the vehicle has become inoperable, the vehicle has run out of gas or electric charge, scheduled maintenance is due, etc.).

In the scenario where an owner desires an unlimited access and use of the vehicle, DVK owner manager 104, based on owner input, creates or accesses a previously created unlimited use DVK 106. Unlimited use DVK 106 has no conditions set for accessing and/or using the vehicle. The owner may cause vehicle owner computing system 102 to provide unlimited use DVK 106 to vehicle computing system 110 of vehicle 108. Vehicle computing system 110 then provides unlimited access to and use of the vehicle if the unlimited use DVK is verified by DVK vehicle manager 122. Unlimited use DVK 106 may be protected, encrypted, decrypted, verified and/or authenticated by any cryptographic method by DVK owner manager 104 and/or DVK vehicle manager 122.

In the scenario where the owner desires to provide limited access to and use of the vehicle to another party (e.g., a user), DVK owner manager 104, based on owner input, creates or accesses a previously created limited use DVK 120A. Limited use DVK 120A has one or more conditions set for accessing and/or using the vehicle. The owner may cause DVK owner manager 104 of vehicle owner computing system 102 to provide limited use DVK 120A to DVK user manager 118 of vehicle user computing system 116 operated by a user (optionally, via DVK server 105)

Limited use DVK 120A may specify one or more conditions of use for the vehicle (which may include limits on capabilities of the vehicle). The conditions of use may include, for example, vehicle state, door unlocking and locking, unlocking and locking access to the engine, trunk access, engine starting, engine stopping, time, location, speed limit, acceleration limit, braking, seatbelt use, stereo volume, heating and air conditioning settings, suspension settings, road conditions, weather conditions, maximum vehicle loading, maximum vehicle towing, or any other condition sensed, determined or received by the vehicle. In an implementation, the limited use DVK 120A includes the one or more conditions. In another implementation, the limited use DVK indicates a set of one or more conditions to DVK vehicle manager 122 of vehicle computing system 110 (for example, by communicating an identifier or operating code indicating a predefined set of one or more conditions). In some scenarios, the limited use DVK may have the ability to provision other DVKs.

DVK user manager 118 may receive limited use DVK 120B from vehicle owner computing system 102 and/or DVK server 105 and store limited use DVK 120B in a memory of vehicle computing system 116 for later use. When the user desires to access and/or use vehicle 108, DVK user manager 118 of vehicle user computing system 116, based on user input, provides a copy, indication or other information that uniquely and securely identifies limited use DVK 120B to DVK vehicle manager 122 of vehicle computing system 110. DVK vehicle manager 122 verifies the validity of limited use DVK 120B and, if verified, provides access to and/or use of vehicle 108 based at least in part on vehicle state 114 and one or more conditions specified or indicated by limited use DVK 120B. That is, access to and/or use of the vehicle may be allowed in response to the one or more conditions of limited use DVK 120B matching vehicle state 114.

In the example of FIG. 1, environment 100 may include vehicle owner computing system 102, DVK server 105, vehicle user computing system 116, and vehicle computing system 110 that communicate with each other via network 130. Vehicle owner computing system 102, vehicle user computing system 116, and/or vehicle computing system 110 may represent any suitable computing system, such as one or more desktop computers, laptop computers, mainframes, servers, cloud computing systems, etc., capable of sending and receiving information both to and from a network, such as network 130. In some examples, the components of vehicle owner computing system 102, vehicle user computing system 116, and/or vehicle computing system 110 computing system illustrated in FIG. I may reside and execute on the same or separate computing devices and systems operated by and/or under the control of one or more entities. In some examples, DVK server 105 may represent one or more cloud computing systems that provide access to their respective services via a cloud over network 130 to one or more of vehicle owner computing system 102, vehicle user computing system 116, and vehicle computing system 110.

Vehicle owner computing system 102 may include DVK owner manager 112, vehicle user computing system 116 may include DVK user manager 118, and/or vehicle computing system 110 may include DVK vehicle manager 122. DVK owner manager 112 may perform operations described herein using software, hardware, firmware, or a mixture of hardware, software, and firmware residing in and/or executing at vehicle owner computing system 102 to perform functions associated with generating DVKs. Vehicle owner computing system 102 may execute DVK owner manager 112 with multiple processors or multiple devices, as virtual machines executing on underlying hardware, as one or more services of an operating system or computing platform, and/or as one or more executable programs at an application layer of a computing platform of vehicle owner computing system 102. One or more of unlimited use DVK 106 and limited use DVKs 120A-B may be stored in any suitable data store, such as a database, a repository, a blockchain, a journal, a certificate authority, and the like for storing data associated with generating DVKs by vehicle owner computing system 102.

DVK user manager 118 may perform operations described herein using software, hardware, firmware, or a mixture of hardware, software, and firmware residing in and/or executing at vehicle user computing system 116 to perform functions associated with using DVKs. Vehicle user computing system 116 may execute DVK user manager 118 with multiple processors or multiple devices, as virtual machines executing on underlying hardware, as one or more services of an operating system or computing platform, and/or as one or more executable programs at an application layer of a computing platform of vehicle user computing system 116. Limited use DVK 120 may be stored in any suitable data store, such as a database, a repository, a blockchain, a journal, a certificate authority, and the like for storing data associated with using DVKs by vehicle user computing system 116.

DVK vehicle manager 110 may perform operations described herein using software, hardware, firmware, or a mixture of hardware, software, and firmware residing in and/or executing at vehicle computing system 110 to perform functions associated with verifying DVKs and allowing access to vehicles when verified. Vehicle computing system 110 may execute DVK vehicle manager 122 with multiple processors or multiple devices, as virtual machines executing on underlying hardware, as one or more services of an operating system or computing platform, and/or as one or more executable programs at an application layer of a computing platform of vehicle computing system 110. One or more of unlimited use DVK 106, limited use DVKs 120A-B, and vehicle state 114 may be stored in any suitable data store, such as a database, a repository, a blockchain, a journal, a certificate authority, and the like for storing data associated with DVKs by vehicle computing system 110.

Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between DVK server 105, vehicle owner computing system 102, vehicle user computing system 116, and vehicle computing system 110. DVK server 105, vehicle owner computing system 102, vehicle user computing system 116, and vehicle computing system 110 may transmit and receive data across network 130 using any suitable communication techniques. Each of DVK server 105, vehicle owner computing system 102, vehicle user computing system 116, and vehicle computing system 110 may be operatively coupled to network 130 using respective network links, such as Ethernet, Wi-Fi, satellite (including cellular satellite) or any other types of wired and/or wireless network connections.

Each of DVK server 105, vehicle owner computing system 102, vehicle user computing system 116, and vehicle computing system 110 represent an individual mobile or non-mobile computing device. Examples of such computing systems include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a gaming system, a media player, an e-book reader, a mobile television platform, an automobile navigation or infotainment system, or any other type of mobile, non-mobile, wearable, and non-wearable computing device.

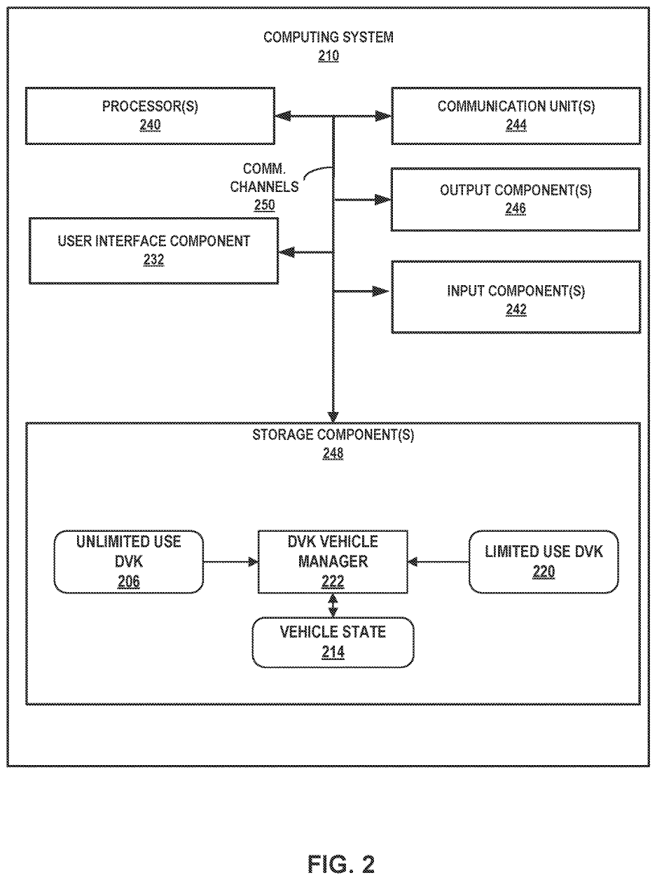

FIG. 2 is a block diagram illustrating further details of an example computing system, in accordance with one or more aspects of the present disclosure. Computing system 210 of FIG. 2 is described below as an example of vehicle computing system 110 as illustrated in FIG. 1.

Computing system 210 of FIG. 2 may be an example of a mobile phone, a tablet computer, a laptop computer, a desktop computer, a server, a mainframe, a set-top box, a television, a wearable device, a home automation device or system, a gaming system, a media player, an e-book reader, a mobile television platform, an automobile navigation or infotainment system, or any other type of mobile, non-mobile, wearable, and non-wearable computing device configured to receive, and output an indication of notification data. In an example, computing system 210 is disposed within a vehicle. FIG. 2 illustrates only one example of computing system 210, and many other examples of computing system 210 may be used in other instances and may include a subset of the components included in example computing system 210 or may include additional components not shown in FIG. 2. Other instances of computing system 210 may be used as vehicle owner computing system 102 and/or vehicle user computing system 116.

As shown in the example of FIG. 2, computing system 210 includes UIC 232, one or more processors 240, one or more input components 242, one or more communication units 244, one or more output components 246, and one or more storage components 248. One or more storage components 248 of computing system 210 also include DVK vehicle manager 222 (an example of DVK vehicle manager 122), unlimited use DVK 206 (an example of unlimited use DVK 106), limited use DVK 220 (an example of limited use DVK 220), and vehicle state 214 (an example of vehicle state 114).

Communication channels 250 may interconnect each of the components 240, 212, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing system 210 may receive input. Examples of input are tactile, audio, and video input. Input components 242 of computing system 210, in one example, includes a presence-sensitive display, touch-sensitive screen, mouse, keyboard, voice responsive system, video camera, microphone or any other type of device for detecting input from a human or machine.

One or more output components 246 of computing system 210 may generate output. Examples of output are tactile, audio, and video output. Output components 246 of computing system 210, in one example, includes a presence-sensitive display, sound card, video graphics adapter card, speaker, liquid crystal display (LCD), organic light-emitting diode (OLED) display, a light field display, haptic motors, linear actuating devices, or any other type of device for generating output to a human or machine.

One or more communication units 244 of computing system 210 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 232 of computing system 210 may be hardware that functions as an input and/or output device for computing system 210. For example, UIC 232 may include a display component, which may be a screen at which information is displayed by UIC 232 and a presence-sensitive input component that may detect an object at and/or near the display component.

One or more processors 240 may implement functionality and/or execute instructions within computing system 210. For example, one or more processors 240 on computing system 210 may receive and execute instructions stored by one or more storage components 248 that execute the functionality of DVK vehicle manager 222. The instructions executed by one or more processors 240 may cause computing system 210 to store information within one or more storage components 248 during program execution.

Examples of one or more processors 240 include application processors, display controllers, sensor hubs, and any other hardware configured to function as a processing unit. One or more processors 240 may execute instructions of DVK vehicle manager 222 to perform actions or functions. That is, DVK vehicle manager 222 may be operable by one or more processors 240 to perform various actions or functions of computing system 210.

One or more storage components 248 within computing system 210 may store information for processing during operation of computing system 210. That is, computing system 210 may store data accessed by DVK vehicle manager 222 module 216 during execution at computing system 210. In some examples, one or more storage component 248 is a temporary memory, meaning that a primary purpose of one or more storage component 248 is not long-term storage. One or more storage components 248 on computing system 210 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

One or more storage components 248, in some examples, also include one or more computer-readable storage media. One or more storage components 248 may be configured to store larger amounts of information than volatile memory. One or more storage components 248 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. One or more storage components 248 may store program instructions and/or information (e.g., data) associated with DVK vehicle manager 222. DVK vehicle manager 222 may execute at one or more processors 240 to perform functions similar to that of DVK vehicle manager 122 of FIG. 1.

DVK vehicle manager 222, when executed by one or more processors 240, may receive vehicle state 214 from one or more input components 242 and store the vehicle state in one or more storage components 248. One or more input components 242 may receive vehicle state 214 from a computing system operated by the owner of the vehicle. Vehicle state 214 received by computing system 210 may include a restriction of limited use of the vehicle by a temporary user of the vehicle. The restriction of limited use of the vehicle by a temporary user of the vehicle in vehicle state 214 may include one of a restriction of limited use for a family member of the owner of the vehicle, a restriction of limited used for a renter of the vehicle, and a restriction of limited use of a mechanic of the vehicle. DVK vehicle manager 222, when executed by one or more processors 240, may receive the limited use digital vehicle key from a computing system operated by a user who is not an owner of the vehicle. Vehicle state 214 may be set, based at least in part on one or more operating status of the vehicle, by the vehicle, prior to verifying the limited use digital vehicle key. DVK vehicle manager 222, when executed by one or more processors 240, may provide access, wherein access may include one or more of unlocking a door of a vehicle and one or more of opening a trunk and frunk of the vehicle. DVK vehicle manager 222, when executed by one or more processors 240, may analyze one or more conditions of the limited use digital vehicle key 120B, the one or more conditions including one or more of time, location, speed limit, and acceleration. Vehicle state 214 may include rental, repair, roadside assistance, and insurance, among other states. Vehicle state 214 may be set by vehicle 108 based at least in part on one or more operating statuses of the vehicle indicating the vehicle is inoperable, to at least one of a repair state, a roadside assistance state and an insurance state, prior to verifying the limited use DVK 120B.

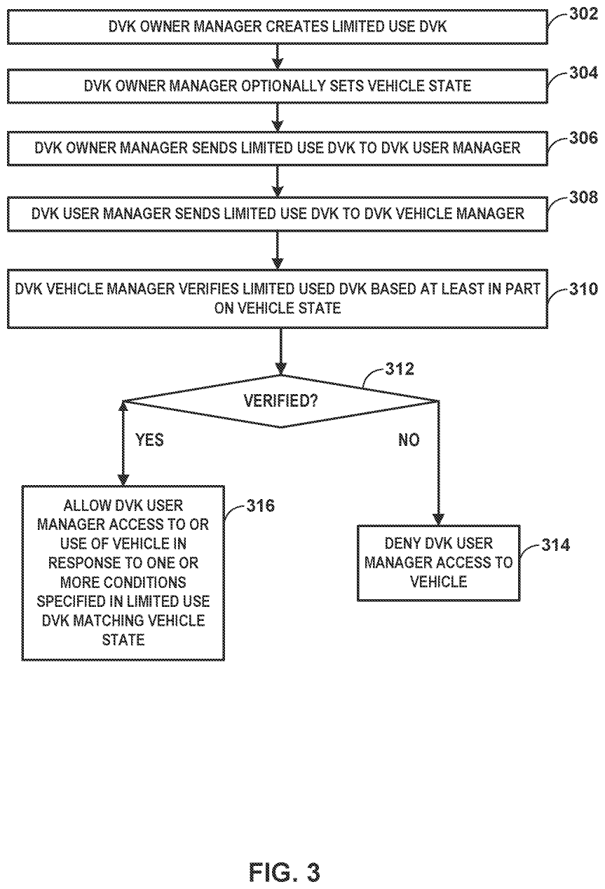

FIG. 3 is a flow chart of an example process for example computing systems to create and use a limited use digital vehicle key, in accordance with aspects of this disclosure. According to an example, one or more process blocks of FIG. 3 may be performed by vehicle owner computing system 102, vehicle user computing system 116, and/or vehicle computing system 110 shown in FIG. 1. As shown in FIG. 3, the process may include DVK owner manager 104 of vehicle owner computing system 102 at block 302 creates, based at least in part on owner input, limited use DVK 120, At block 304, DVK owner manager 104 optionally sets a current value for vehicle state 114 in vehicle 108 (which may include restrictions on use of the vehicle as defined by one or more conditions). In another scenario, vehicle 108 sets the current value for vehicle state 114 based at least in part on current operating status of the vehicle (which may include input data from one or more sensors of the vehicle). At block 306, DVK owner manager 104 sends limited use DVK 120 to DVK user manager 118 of vehicle user computing system 116. When the user desires to access and/or use vehicle 108, DVK user manager 118, based on user input, at block 308 sends limited use DVK 120 to DVK vehicle manager 122 in vehicle computing system 110. At block 310, DVK vehicle manager 122 verifies limited use DVK 120 based at least in part on vehicle state 114. In an implementation, verification of limited use DVK 120 may include decryption operations and authentication operations. At block 312, if limited use DVK 120 is verified, then at block 316 DVK vehicle manager 122 allows the user, via DVK user manager 118, access to and/or use of vehicle 108 in response to one or more conditions specified (or indicated by) limited use DVK 120 matching vehicle state 114. At block 312, if limited use DVK 120 is not verified, then at block 314 DVK vehicle manager 122 denies the user, via DVK user manager 118, access to and use of vehicle 108.

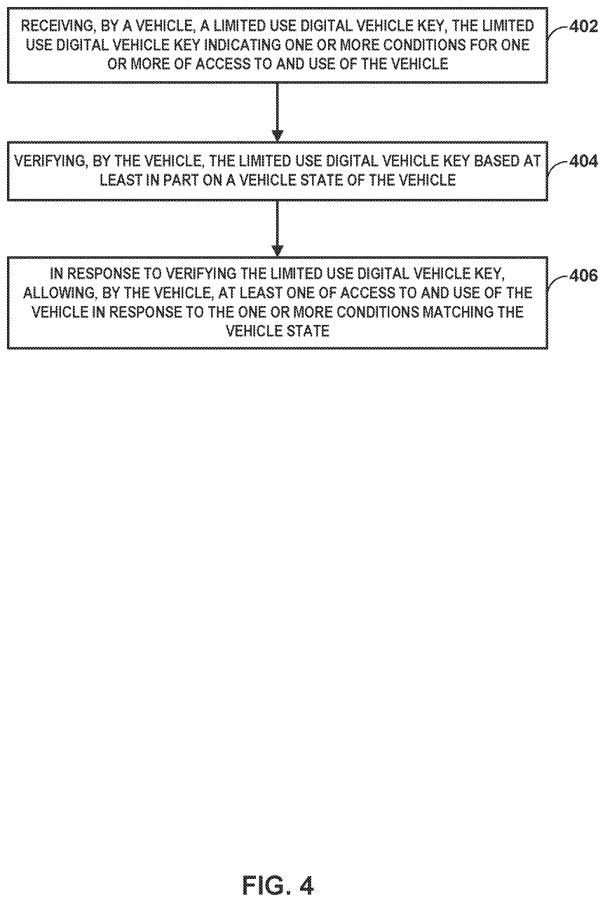

FIG. 4 is a flow chart of an example process for an example computing system to receive and verify a limited use digital vehicle key, in accordance with aspects of this disclosure. According to an example, one or more process blocks of FIG. 4 may be performed by DVK vehicle manager 222 of vehicle computing system 110 shown in FIG. 1.

At block 402, method 400 includes receiving, by vehicle 108, a limited use digital vehicle key 120, the limited use digital vehicle key indicating one or more conditions for one or more of access to and use of the vehicle.

At block 404, method 400 includes verifying, by vehicle 108, the limited use digital vehicle key 120 based at least in part on a vehicle state 114 of the vehicle.

At block 404, method 400 includes in response to verifying the limited use digital vehicle key, allowing, by the vehicle, at least one of access to and use of the vehicle in response to the one or more conditions matching vehicle state 114.

In this way, various aspects of the techniques described in this disclosure may enable the following examples.

Example 1 is a method including receiving, by a vehicle, a limited use digital vehicle key, the limited use digital vehicle key indicating one or more conditions for one or more of access to and use of the vehicle; verifying, by the vehicle, the limited use digital vehicle key based at least in part on a vehicle state of the vehicle; and in response to verifying the limited use digital vehicle, allowing, by the vehicle, at least one of access to and use of the vehicle in response to the one or more conditions of the limited use digital key matching the vehicle state.

Example 2. The method of example 1, further comprising receiving the vehicle state by the vehicle prior to verifying the limited use digital vehicle key.

Example 3. The method of any one of examples 1 to 2, further comprising receiving the vehicle state from a computing system operated by the owner.

Example 4. The method of any one of examples 1 to 3, wherein the vehicle state comprises a restriction of limited use of the vehicle by a temporary user of the vehicle.

Example 5. The method of any one of examples 1 to 4, further comprising receiving the limited use digital vehicle key from a computing system operated by a user who is not an owner of the vehicle.

Example 6. The method of any one of examples 1 to 5, further comprising setting, based at least in part on one or more operating statuses of the vehicle, the vehicle state by the vehicle, prior to verifying the limited use digital vehicle key.

Example 7. The method of any one of examples 1 to 6, wherein access to the vehicle comprises one or more of unlocking a door of the vehicle and one of opening a trunk and frunk of the vehicle.

Example 8. The method of any one of examples 1 to 7, wherein the one or more conditions comprises one or more of time, location, speed limit, and acceleration.

Example 9. The method of any one of examples 1 to 8, wherein the vehicle state comprises one of a rental state, a repair state, a roadside assistance state, and an insurance state.

Example 10. The method of any one of examples 4 to 9, including setting, based at least in part on one or more operating statuses of the vehicle indicating the vehicle is inoperable, the vehicle state by the vehicle to at least one of a repair state, a roadside assistance state and an insurance state, prior to verifying the limited use digital vehicle key.

Example 11 is a system including a processor, and a storage medium storing instructions, which when executed by the processor cause the system to perform the method of any one of claims 1 to 10.

Example 12 is a machine-readable medium comprising instructions, which when executed by one or more processors of a machine, causes the machine to perform the method of any one of claims 1-10.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

1. A method comprising:
receiving, by a vehicle, a limited use digital vehicle key, the limited use digital vehicle key indicating one or more conditions for one or more of access to and use of the vehicle;
verifying, by the vehicle, the limited use digital vehicle key based at least in part on a vehicle state of the vehicle; and
in response to verifying the limited use digital vehicle, allowing, by the vehicle, at least one of access to and use of the vehicle in response to the one or more conditions of the limited use digital vehicle key matching the vehicle state.

2. The method of claim 1, further comprising receiving the vehicle state by the vehicle prior to verifying the limited use digital vehicle key.

3. The method of claim 1, further comprising receiving the vehicle state from a computing system operated by an owner of the vehicle.

4. The method of claim 1, wherein the vehicle state comprises a restriction of limited use of the vehicle by a temporary user of the vehicle.

5. The method of claim 1, further comprising receiving the limited use digital vehicle key from a computing system operated by a user who is not an owner of the vehicle.

6. The method of claim 1, further comprising setting, based at least in part on one or more operating statuses of the vehicle, the vehicle state by the vehicle, prior to verifying the limited use digital vehicle key.

7. The method of claim 1, wherein access to the vehicle comprises one or more of unlocking a door of the vehicle and one of opening a trunk and frunk of the vehicle.

8. The method of claim 1, wherein the one or more conditions comprises one or more of time, location, speed limit, and acceleration.

9. The method of claim 1, wherein the vehicle state includes one or more of a rental state, a repair state, a roadside assistance state, or an insurance state.

10. The method of claim 1, further comprising:
comprising setting, based at least in part on one or more operating statuses of the vehicle indicating the vehicle is inoperable, the vehicle state by the vehicle to at least one of a repair state, a roadside assistance state and an insurance state, prior to verifying the limited use digital vehicle key.

11. A computing device comprising:
a memory; and
a processor in communication with the memory and configured to:
receive a limited use digital vehicle key, the limited use digital vehicle key indicating one or more conditions for one or more of access to and use of the vehicle;
verify the limited use digital vehicle key based at least in part on a vehicle state of the vehicle; and
in response to verifying the limited use digital vehicle, allowing, by the vehicle, at least one of access to and use of the vehicle in response to the one or more conditions of the limited use digital vehicle key matching the vehicle state.

12. A non-transitory machine-readable medium comprising instructions that, when executed, cause one or more processors of a computing device to:
receive a limited use digital vehicle key, the limited use digital vehicle key indicating one or more conditions for one or more of access to and use of the vehicle;
verify the limited use digital vehicle key based at least in part on a vehicle state of the vehicle; and
in response to verifying the limited use digital vehicle, allowing, by the vehicle, at least one of access to and use of the vehicle in response to the one or more conditions of the limited use digital vehicle key matching the vehicle state.

13. The computing device of claim 11, wherein the processor is further configured to:
receive the vehicle state by the vehicle prior to verifying the limited use digital vehicle key.

14. The computing device of claim 11, wherein the processor is further configured to:
receive the vehicle state from a computing system operated by an owner of the vehicle.

15. The computing device of claim 11, wherein the vehicle state comprises a restriction of limited use of the vehicle by a temporary user of the vehicle.

16. The computing device of claim 11, wherein the processor is further configured to:
receive the limited use digital vehicle key from a computing system operated by a user who is not an owner of the vehicle.

17. The non-transitory machine-readable medium of claim 12, wherein the instructions further cause the one or more processors of the computing device to:
receive the vehicle state by the vehicle prior to verifying the limited use digital vehicle key.

18. The non-transitory machine-readable medium of claim 12, wherein the instructions further cause the one or more processors of the computing device to:
receive the vehicle state from a computing system operated by an owner of the vehicle.

19. The non-transitory machine-readable medium of claim 12, wherein the instructions further cause the one or more processors of the computing device to:
receive the limited use digital vehicle key from a computing system operated by a user who is not an owner of the vehicle.

20. The non-transitory machine-readable medium of claim 12, wherein the vehicle state comprises a restriction of limited use of the vehicle by a temporary user of the vehicle.
